(19) United States
(12) Patent Application Publication
(10) Pub. No.: US 2013/0060729 A1
(43) Pub. Date: Mar. 7, 2013

(54) DISASTER AND EMERGENCY MANAGEMENT SYSTEM

(71) Applicant: Curtis Massey, Virginia Beach, VA (US)

(72) Inventor: Curtis Massey, Virginia Beach, VA (US)

(21) Appl. No.: 13/407,753

(22) Filed: Feb. 28, 2012

Related U.S. Application Data
(60) Provisional application No. 61/447,666, filed on Feb. 28, 2011.
(60) Provisional application No. 61/479,011, filed on Apr. 26, 2011.

(51) Int. Cl. G06F 7/00; G06F 17/30

(52) U.S. Cl. 707/600; 707/E17.007; 707/E17.032

(57) ABSTRACT

A user interface for providing emergency and other information to an end user, where the information is stored locally on a portable device. The present invention provides real-time access to disaster and/or critical event pre-planning as well as real-time information correlation related to the management and control of disasters and other emergencies in addition to disaster pre-planning utilizing portable tablet devices. The present invention is an application that resides on a user's portable electronic device such as a tablet, and may be served by push and/or demand from a server or cloud data service. The application includes information related to pre-disaster planning as well as disaster response during an actual emergency or disaster event. The application structure is designed to provide emergency, disaster, and building planning information for both commercial and/or building interests, government and municipalities, and for individuals and families.

This Application claims the benefit of U.S. Provisional Apps. Nos. 61/447,666 filed on Feb. 8, 2011 and 61/479,011 filed on Apr. 26, 2011.

### BACKGROUND OF THE INVENTION

1. Field of the Invention

The present invention relates generally to the field of disaster planning and response, and more particularly to systems and methods for providing disaster and emergency planning, preparation and response information. In particular the present invention relates to real-time access to disaster and/or critical event pre-planning as well as real-time information correlation related to the management and control of disasters and other emergencies in addition to disaster pre-planning utilizing portable tablet devices. The present invention is an application that resides on a user's portable electronic device such as a tablet, and may be served by push and/or demand from a server or cloud data service. The application includes information related to pre-disaster planning as well as disaster response during an actual emergency or disaster event. The application structure is designed to provide emergency, disaster, and building planning information for both commercial and/or building interests, government and municipalities, and for individuals and families.

a. Commercial, Corporate, and Governmental Interests.

Disasters and emergencies are becoming increasingly complicated to manage and control. As a result, modern disaster management requires advanced planning and broad databases of both general and disaster/site specific information. In addition to increases in population and population density, the modern crisis manager must deal with complicated threat and exposure issues (i.e., as a result of modem building materials) building issues related to height, construction components, and the like. In addition, modern disaster response often requires the incorporation of numerous response vehicles from various organizations. Depending upon the disaster or emergency, this may include: fire and rescue; specialized fire and rescue (i.e., water and/or technical rescue teams); hazardous materials response teams; local, state, and/or federal law enforcement; special local, state, and/or federal agencies (i.e., U.S. Secret Service, U.S. Border Patrol); and other agencies and organizations such as international teams provided in response to major disasters, such as the international response to a major earthquake in Haiti in January of 2010. Broadly, this category of disaster and emergency information can be broken into pre-planning, real-time emergency and disaster response, and training.

b. Individual and/or Private Interests.

Modern disaster and emergency planning and management is not limited to corporate, commercial, or municipality/government interests, however. Personal emergency information that will allow an individual and family to understand and respond to various emergency situations is also desirable. Regardless of where an individual is—at home, at work, on vacation, or elsewhere—information regarding imminent and/or real-time dangerous events can be critical.

In order to handle the dissemination and correlation of disaster and emergency information, the invention disclosed herein is geared generally towards providing disaster and emergency planning information in an easy to handle single application that is universal and provides not just planning information but also real-time critical information.

2. Description of the Prior Art

Disaster and emergency planning and response systems are well known in the art. For example, many large buildings and organizations keep pre-plans for fire and other emergencies that are site-specific, such as the management company for a high rise building keeping binders of information related to building design, floor plans, standpipe connections, and the like. Some general information related to the site may include but is not limited to:
Location, including cross streets, box (fire dept) location and contents (e.g., pre-fire plan books, floor plans, etc.);
Fire Dept. Summary, including projected building population (by time of day), critical concerns—these are site specific, and may include modifications to building structure or building structure that deviates from normal building construction; elevators and operation; summary of power supplies and electrical room locations; Stairwells; Gas risers;

Where extra manpower/resources are required;

General Building construction concerns;

Water supplies, including location, coverage, flow rates and pressures, etc.;
Ventilation concerns, including the availability and design of ventilation systems that may handle smoke and/or hazardous materials;
Access concerns, including general and specialized access points and roof access/helipad availability; and

Hazardous materials types and locations.

In addition, disaster planning for a site generally provides a Table of Contents that is specific to the site. Such a Table of Contents may include but is not limited to:
General building data;
Fire Department concerns;
Water supply;
Elevators;
Ventilation systems;
Building access;
Alarm systems;
Utilities;
Content hazards;
Fire protection systems;
Communication systems;
Security/salvage areas;
Telephone list;
Evacuation check list; and
Floor plans.

But folders and binders are clumsy and take up significant amounts of physical space. For large buildings or structures, to cover all possible contingency plans for disasters and emergencies, the number of documents and physical binders can be cumbersome and may well be impossible for a single person to carry or handle alone. A fire pre-plan for a single site can run into the hundreds or thousands of pages of documents. Further, depending upon the location of the documents and the location/type of disaster or emergency, it may be dangerous or impossible to gain access to the documents when they are needed.

Secondly, searching and accessing paper documents that can number into the hundreds or thousands can be inefficient and time consuming, especially when attempting to coordinate and manage a disaster or emergency of any kind. Cross-referencing through multiple documents and, in a lot of instances, multiple binders, can be so inefficient as to make a portion of the information so inaccessible or time-consuming to find as to be useless. This despite the fact that the information is considered critical enough to be included as part of a pre-plan.

In addition, there is a great deal of site/locality information that cannot practically be included in such plans, but still may be critical to managing a disaster or emergency. Such information may include:
weather information;
local emergency and disaster plans, including such things as fire, rescue, law enforcement, and National Guard availability and deployment;
travel and traffic planning including evacuation plans and routes;
additional hazard information such as infrastructure (i.e., water and power supplies and plants), industrial complexes and the like; medical information including the location and status of hospitals, nursing homes and other similar care facilities;
mass casualty planning;
local, state, and federal law enforcement resources including authority and jurisdiction, contact information, etc.; and
hazardous materials bulletins and locations.

And, by their very nature such plans cannot include every conceivable potential disaster or emergency. For example, biological and chemical attacks, tornadoes, hurricanes, other types of severe and seasonal weather, blackouts, small and large scale acts of terrorist, arson, and the like, to name a few. Such plans can also quickly become outdated for various reasons. Upgrades and changes to large buildings occur often. Physical layout and design changes as well as changes in materials used can dramatically affect the ability of a disaster manager to adequately predict and control portions of a disaster or emergency. Incorporating such changes into a plan requires notice, planning, and then execution to ensure that the pre-plans are correctly updated. Changes to outside knowledge bases can change dramatically how disasters and emergencies are handled. For example, changes and updates in the handling of building materials and hazardous materials in emergencies occur frequently and often with no advance notice from emergency agencies, regulatory agencies, and the like.

Finally, existing plans do not and cannot include real-time information and real-time updates related to weather, planning, manpower and other resource availability, communication and tracking capability to allow disaster management to follow in real time the resources, human and otherwise, that are or can be deployed to handle incidents. Existing plans also do not allow access to the host of available information that can assist in disasters or emergencies, such as mapping and satellite imagery. By leveraging such resources, the present invention provides a significant capability to effectively and knowledgably handle, contain, and control disasters and emergencies. The present invention further provides a mobile application to assist individuals in reacting to and surviving what may otherwise be life-threatening situations.

For personal and/or family disaster or emergency planning and needs, emergency and disaster planning is well known and advised. For example, the Red Cross provides family pre-planning information.

Http://www.redcross.org/portal/site/en/menuitem.d8aaecf214c576bf971e4cfe43181aa0/?vgnexto id=72c51a53f1c3711VgnVCM1000003481a10aRCRD. However, such pre-planning, while always a good idea, does not solve the problem of bringing together all of the pertinent and valuable information that an individual or family may need to either plan for or respond to a disaster or emergency. Such information can include information related to medical emergencies, disease and other hazard warnings for particular locations, vehicular accidents, severe weather matters, political unrest or crime warnings and the like. In sum, the information needed by individuals is varied and changing, and there is a need to provide individuals with a centralized, portable system that gives a user immediate access to planning as well as real-time information to assist them in times of emergency or disaster.

What is needed, therefore, is a single application that provides a database of information that may be utilized to respond to emergencies and disasters, both by commercial and governmental concerns as well as by individuals.

### SUMMARY

The present invention solves the above deficiencies by providing a computer application that provides an end user real-time and portable access to emergency and disaster planning and management information and guidance. In some embodiments, the user interfaces with the invention through a portable device that allows for graphical user interface (i.e., through touch screens or combination rolling ball and keystroke selection), one or more processors, memory and one or more modules, programs or sets of instructions stored in the memory for performing one or more functions and where multiple functions may be performed singly or simultaneously.

The present invention provides a mobile application for providing to end users critical disaster and emergency information which includes static information from databases (which may be updated periodically) both resident in the application and accessed through networking, as well as real-time and forecast emergency and disaster conditions. The information is streamlined by utilizing modern portable computing technology. Documents may be provided electronically as PDF files (a file format created by Adobe Systems) which can be scrolled and searched with ease, including through a live index and word search. Real-time forecast emergency and disaster conditions are provided to the end user either on demand or by automatic “push” as needs dictate. For example, an end user traveling on vacation will have the application monitoring via GPS his position, and notify him automatically of weather or related bulletins specific to his location.

The present invention provides for disaster and emergency planning that is centralized in a single system, referred to herein and in the Figures as the “MasseyApp.” The system may be based upon mobile tablet computers, PDAs, cell phones and the like. The system provides a site-, emergency- and disaster-specific database of information. In addition, the present invention, in one embodiment, provides disaster and emergency information to a general end user so that the general end user has access to disaster and emergency information to assist them in situations for which they are untrained members of the public.

The present invention comprises a computer based system and information resources, where the computer based system includes disaster and emergency pre-planning information that is specifically designed to an end user's needs. The present invention provides both textual and visual information. For example, diagrams are accessible from dedicated links or from textual references to the diagrams and/or the information incorporated into such diagrams. The invention will bring together, in a single end user application, information related to disasters and emergencies.

Small, portable and easily used tablets and related electronic devices (PDAs, cellular telephones, etc.) are utilized, and the present system may comprise a tablet application that is installed on a tablet or similar device. Such tables and portable devices are currently exemplified by Apple® iPad®, Motorola® Xoom™, and other tablet devices, PDAs and cellular telephones such as the Blackberry line of cellular phones and the Apple® iPhone®.

The application may include a pre-designed database that is configured for the end user's site and disaster or emergency needs and is accessible through a directory. In one embodiment, the management company of a building will have a specific site review and disaster plan incorporated into the application so that the user can access immediately specific information related to the site.

In one embodiment, guidelines and information is provided in a corporate and/or commercial setting for preparing for, reacting to and/or recovering from natural and man-made events including: fire; weather; terrorism, security-related issues; natural (non-weather) disasters; medical emergencies; and the like. As an example, in this embodiment, targeted occupancies for buildings include but are not limited to the following structures:
high- and low-rise office;
high- and low-rise residential;
high- and low-rise hotel;
high- and low-rise mixed-use;
shopping areas and malls;
warehouses;
data centers;
call centers;
trading centers;
industrial buildings/complexes.

The groups of end-users for this embodiment may include but is not limited to: owners, Managers, engineering staff, security staff, support staff, and tenants. The embodiment provides graphical information services for weather, terror, and news alerts; standard and emergency instant and other messaging; real-time tie-in to building and/or site specific graphics including but not limited to floor plans, riser diagrams, site plans, evacuation plans/routes, and collapse rescue/column grids. Brief yet detailed textual information accompanies the graphical information. Site specific information such as contacts and hazardous materials may also be provided.

Critical information within the database is preferentially updated by information “push” either at the electronic request of the end user, or on a scheduled and/or as-needed basis by the plan provider from a central monitoring and control system. In an embodiment for a fire pre-plan for a building owner or manager, the system would include in the database critical building information as above. Building specific information can be updated in real-time as the building status changes. For example, floor plans may be updated immediately when build-outs or other changes occur, with the new plans being appended electronically to the disaster and emergency management system through the central server or through a cloud computing configuration, and thence to the individual tablets.

Further, the system preferentially provides links to external information as listed above, such as local municipality information, emergency planning, weather, mapping and GPS and the like. An end user can, from within the system, immediately request and see physical location and access satellite mapping and viewing systems such as Mapquest®, Google® Maps, and Google® Earth®.

In a preferred embodiment, the system application runs in the background of the device while the device is operating, and both queries for and receives information updates related to the site and emergency information included in the system. For example, changing fire threats and forecasts may automatically be updated through public fire services in real time, giving the end user immediate information related to fire threat in the area. The system will also preferentially include real time immediate access to weather, both immediately and forecast. Other related but critical information that is preferentially provided to the end user, either on demand or by “push” when critical information is changed, may include:
local emergency and disaster plans, including such things as fire, rescue, law enforcement, and National Guard availability and deployment;
travel and traffic planning including evacuation plans and routes; additional hazard information such as infrastructure (i.e., water and power supplies and plants), industrial complexes and the like; medical information including the location and status of hospitals, nursing homes and other similar care facilities;
mass casualty planning;
local, state, and federal law enforcement resources including authority and jurisdiction, contact information, etc.; and
hazardous materials bulletins and locations.

In another embodiment, the system is provided to emergency providers so that the database of information provided to a building owner or manager is immediately available to emergency service providers. In one embodiment, the information is stored for all of the buildings and sites within the zone of control of the emergency response provider or organization. In another embodiment, the information is provided on demand when requested by the emergency response provider. In either case, in preferred embodiment, as the database for a building or site is updated, the emergency response provider's system is simultaneously synchronized and updated.

In another embodiment, the system is provided to general users, with real-time monitoring Of position and disaster/emergency threats and information. In this embodiment, an end user finding themselves in an emergency situation can preferentially access real time data about the type of emergency, where and how to get medical and other emergency help, how to modify their travel plans as necessary to accommodate the emergency, and the like. In such a public configuration, the system includes a database that, when activated, coordinates and receives information from the central monitoring and control system.

In another embodiment, the central monitoring and control system provides information to the system that allows the system to then automatically identify and access localized information sources for emergency and other information. For example, the system would be provided with the closest National Weather Service data push, and the system would then receive information from the National Weather Service specifically related to the physical location of the end user.

In a further embodiment, the invention provides for an individual and/or personal application emergency information database which may include information specific work, home and travel emergency pre-planning and the like. In this embodiment, the invention may further incorporate a personal critical information database which may comprise the following individual- or family-specific information: insurance, bank records, credit card information, passport information, listing of valuables, vehicle information, medical information and history, contact information, and the like.

In another embodiment, the invention provides for voice recognition interface and language translation.

In yet another embodiment, the invention provides knowledge and information services that are stored within the mobile device and may be accessed and operated without data or other connectivity.

In another embodiment, the invention integrates Global Positioning services.

A further embodiment of the present invention provides emergency management and guidance to defined users for: transportation; emergency management and response (e.g., fire and rescue, police, medical services and facilities, etc.); and military and homeland defense/security concerns.

Another embodiment of the present invention incorporates the database and user interface services to non-commercial and non-professional users. Expanded knowledge base and information services are provided for individuals and families, including emergency and non-emergency information such as: “lost in the woods” scenarios; cruise ship emergencies; finding evacuation routes and other information related to being safe in situations involving potentially life- and property-threatening emergencies or problems. Day-to-day events may be included, providing information relating to such things as safety and guidance in changing tires, fixing roofs, stopping leaks, etc.

Another embodiment of the present invention provides databases of checklists for all included emergency and non-emergency functions. Such checklists can also include critical information such as contacts, document information and location (i.e., insurance policies and the like).

In another embodiment of the present invention, the invention is incorporated into existing mobile devices and information repositories such as vehicle GPS guidance systems and the like.

The invention therefore provides for emergency- and non-emergency information that is readily accessible, portable, and may be utilized by both professional and non-professional end users.

### DESCRIPTION OF THE DRAWINGS

FIG. 1 is a sample Table of Contents for a disaster pre-plan.

FIG. 2 is a sample structural diagram for a disaster pre-plan.

FIG. 3 is a sample standpipe riser diagram for a disaster pre-plan.

FIG. 4 is a sample elevator shaft diagram for a disaster pre-plan.

FIG. 5 is a sample ventilation riser diagram for a disaster pre-plan.

FIG. 6 is a diagram of an embodiment of the present invention for providing disaster and emergency information to an end user.

FIG. 7 is a diagram of an embodiment of the present invention showing the organization and access to information related to disaster or emergency events.

FIG. 8 is a diagram of an embodiment of the present invention showing the organization of day-to-day operation information for building and commercial concerns.

FIG. 9 is a diagram of an embodiment of the present invention showing the organization of disaster recovery concerns.

FIG. 10 is a diagram of an embodiment of the present invention showing the organization of a public application of the present invention.

FIG. 11 is a flowchart illustrating an installation process for the present invention.

FIG. 12 is a flowchart illustrating the installing of site-specific information for a specific physical location and/or building.

FIG. 13 is a diagram of the interaction of the present invention with a static server and a cloud-based information service.

FIG. 14 is a flow chart demonstrating an aspect of the invention where User Generated Content (UGC) is synchronized with a static server and updated In local and static server databases.

FIG. 15 is a flow chart demonstrating an aspect of the invention where User Generated Content meta- and other data is updated and synchronized between a portable user device database and a static database.

The present invention will be understood in light of the Figures, as well as the following description.

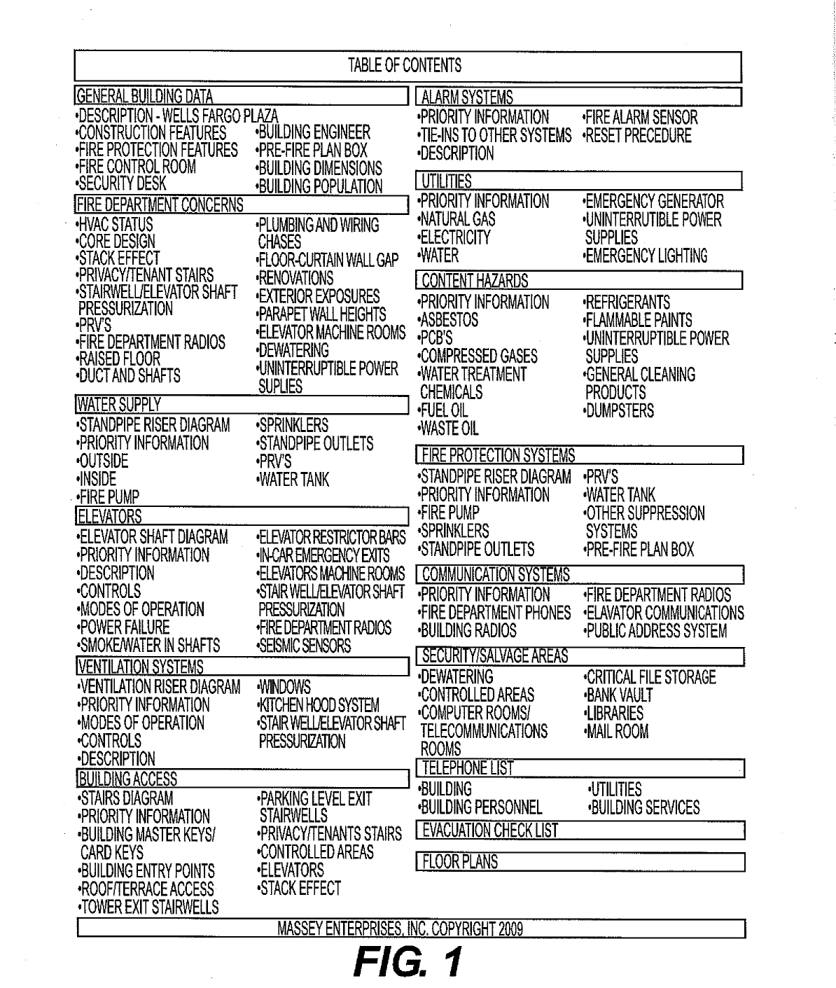

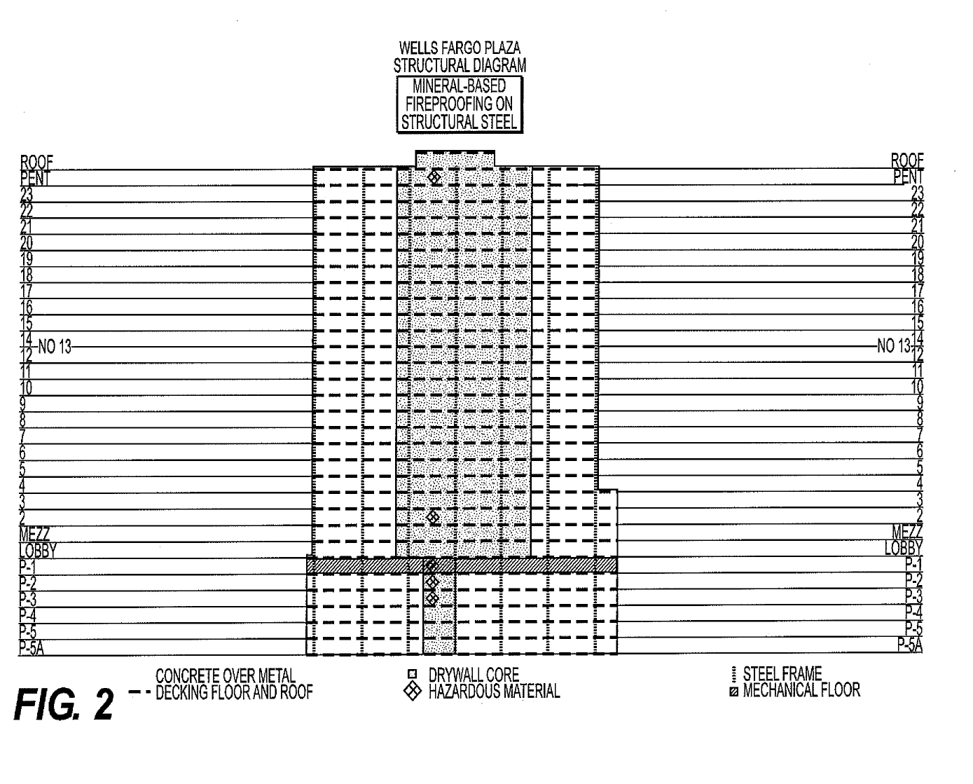

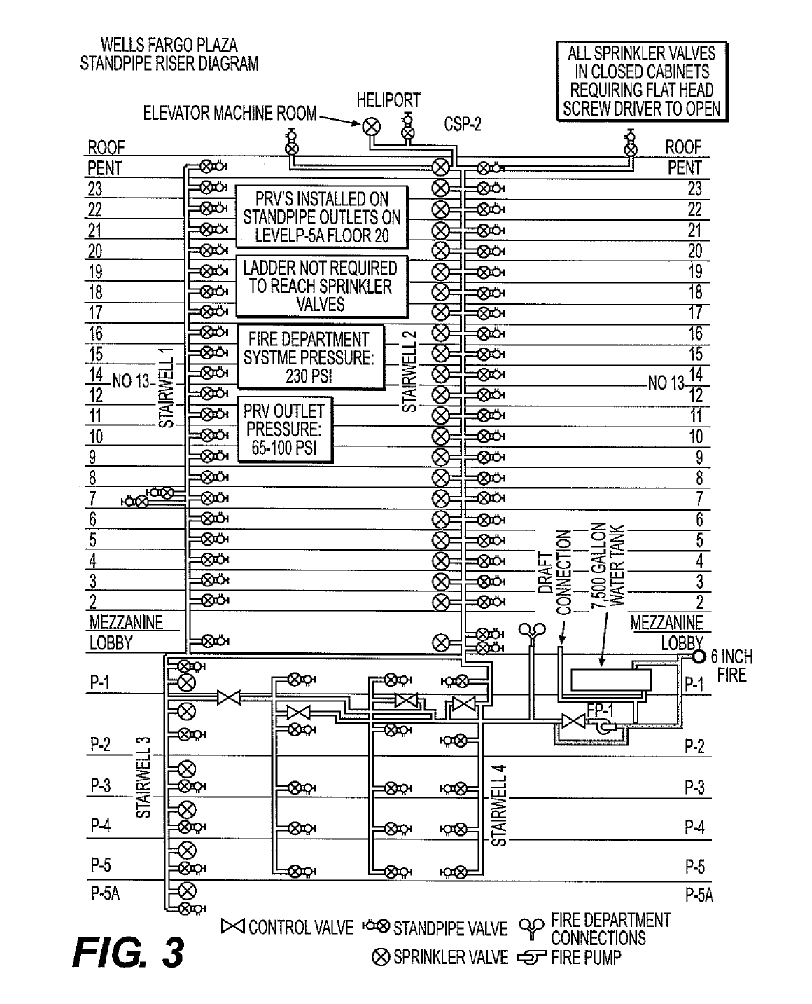

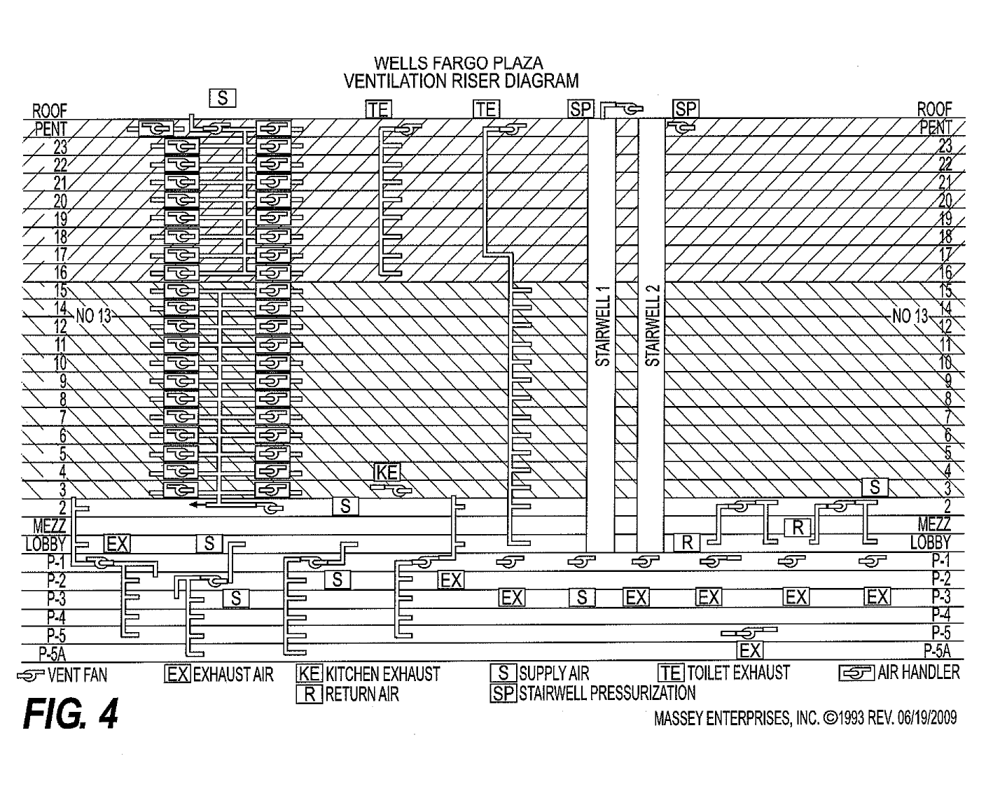

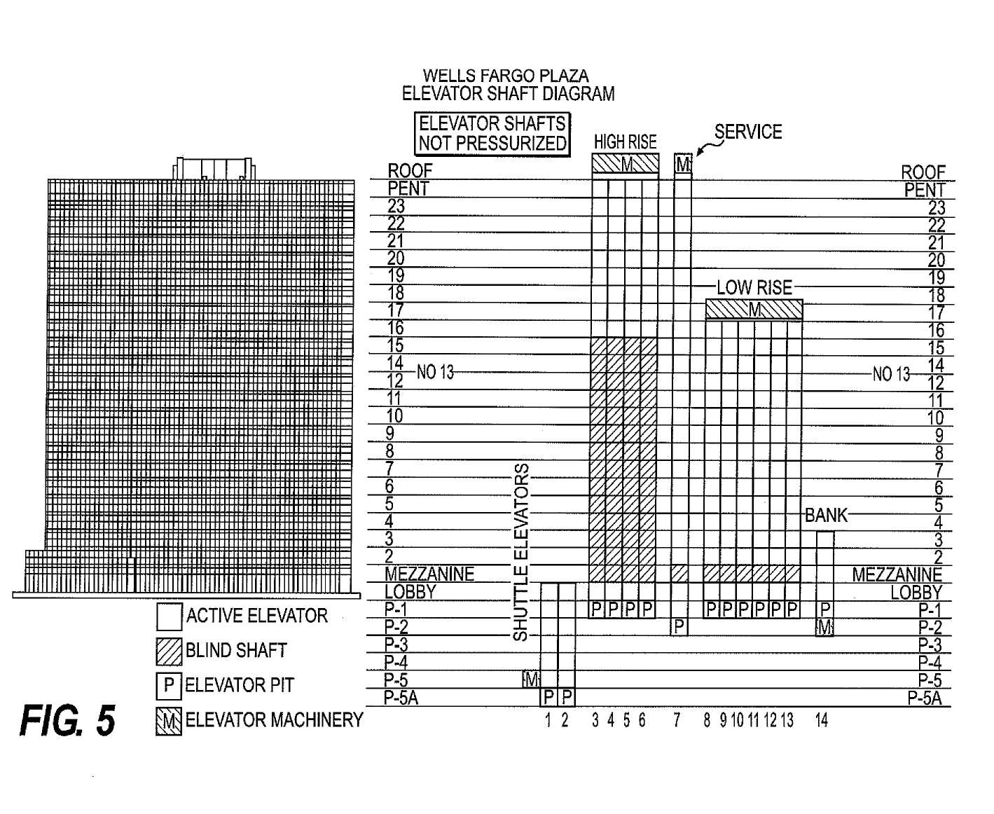

FIGS. 1-5 provide samples of plan information provided to the end user within the system; the specifics of the information are tailored specifically to the end user's site and needs. The database and associated application are installed on a portable device. The portable device preferentially includes communication means and GPS means. The present system may be provided complete with the tablet or other device, or may be provided as an application to be installed and used by the end-user on a pre-existing device.

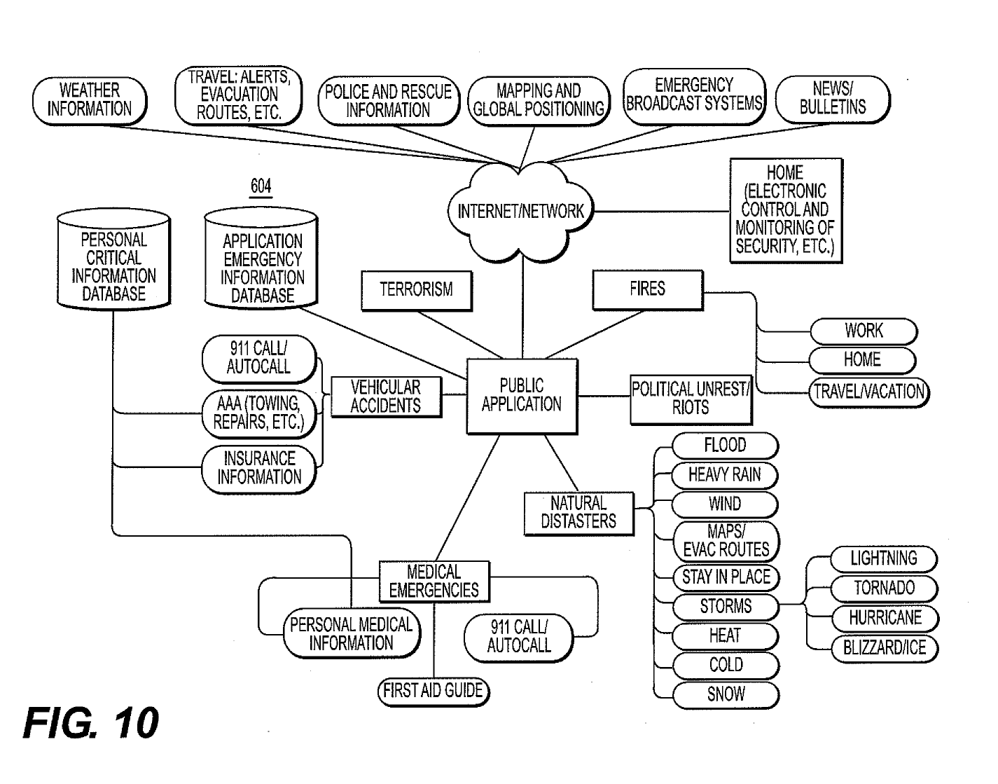

The present invention is supported on IOS (Apple®), Android, and Blackberry but it will be understood that the invention can be utilized on any stationary or mobile platform. The invention is comprised of two components: a user interface and a content management system. The user interface allows the end user (such as a property manager or the like) to enter site- or emergency-critical information that is stored and readily available as needed. An embodiment of the application as applied to a public (individual) end user is shown in FIG. 10.

It will be understood that the information provided to the end user's system may be provided over the internet, through telephonic systems, through other signaling means, and the like.

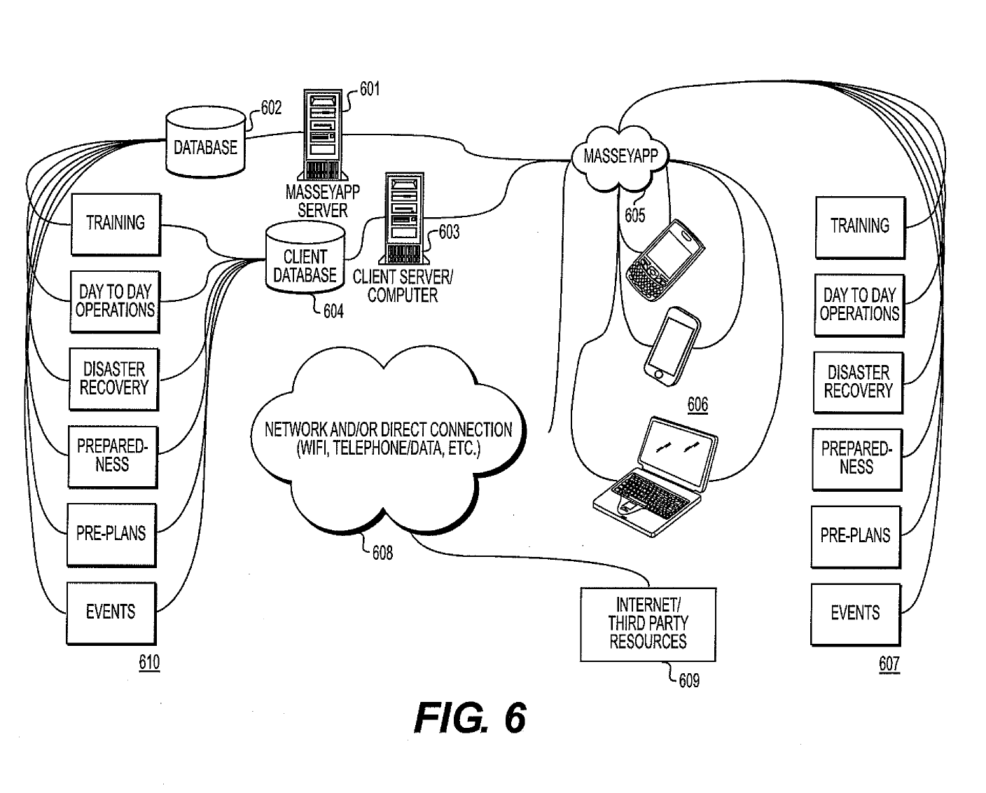

FIG. 6 is a diagram of an embodiment of the present invention. for providing disaster and emergency information to an end user.

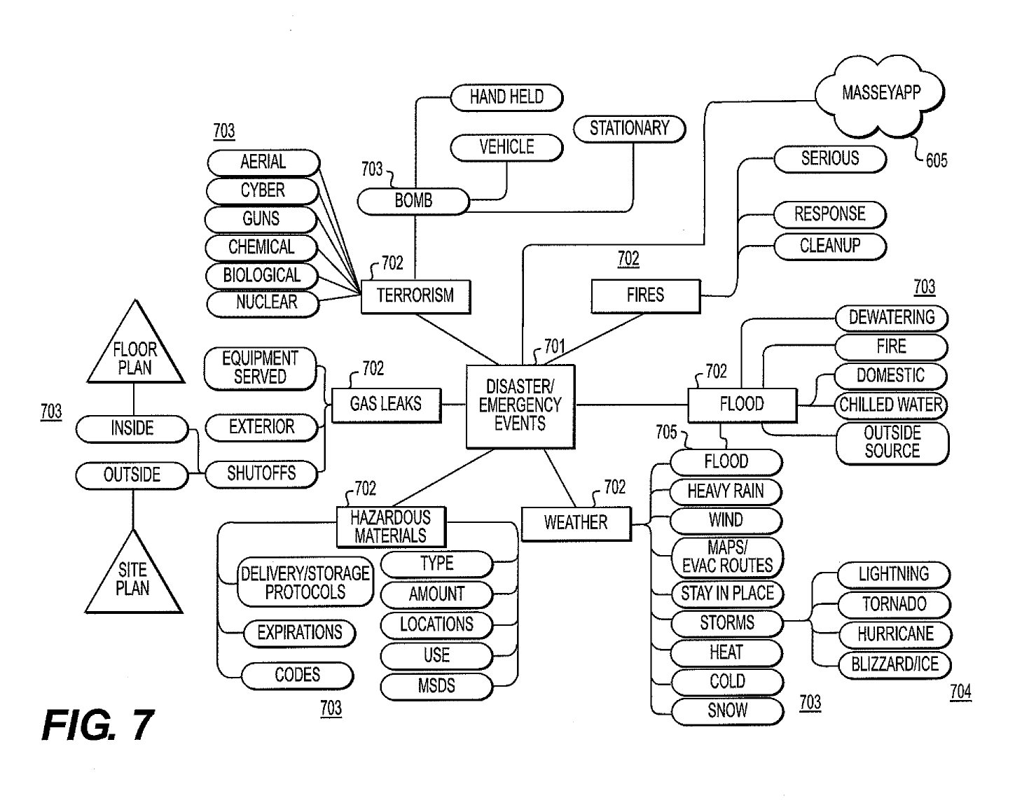

FIG. 7 is a diagram of an embodiment of the present invention showing the organization and access to information related to disaster or emergency events. The MasseyApp 605 provides the interface for a user to choose from the primary group the sub-group DISASTER/EMERGENCY EVENTS 701. Subgroups 702 further provide information related to specific events; in this example, events include Terrorism, Fire, Flood, Weather, Hazardous Materials, and Gas Leaks. Further, specific guidance and information is provided in sub-sub groups 703 and 704. Because of the nature of emergency events, there may be some overlap of planning and guidance, and a user is directed 705 between groups, as is shown for the subgroup 702 FLOOD with the sub-subgroup 703 Flood.

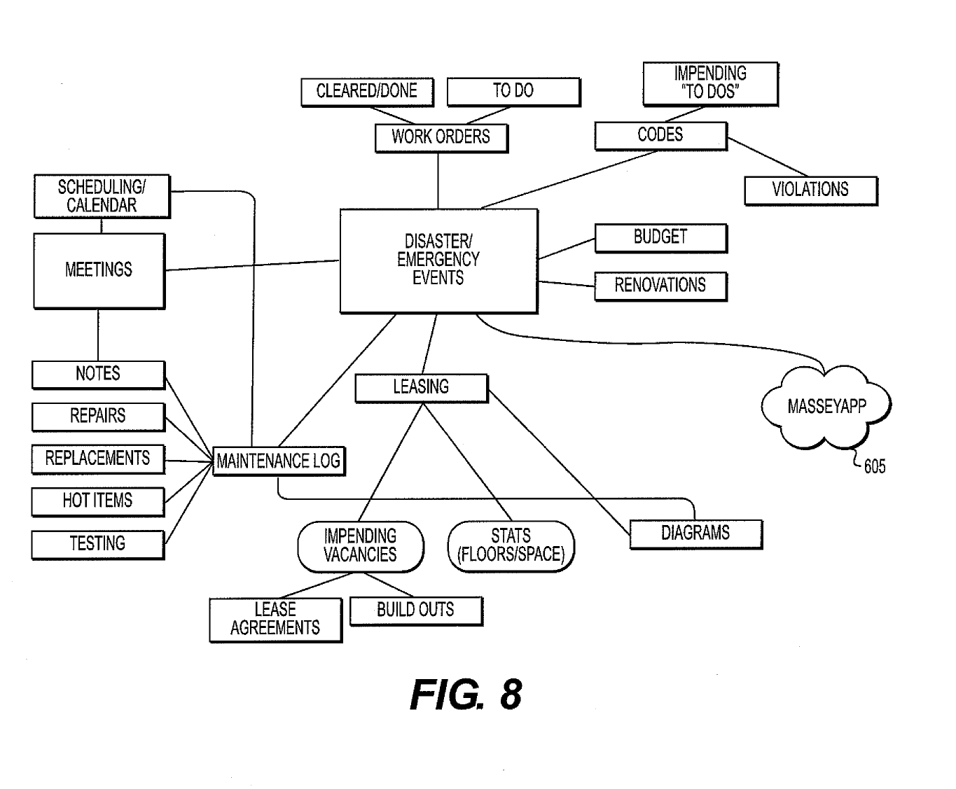

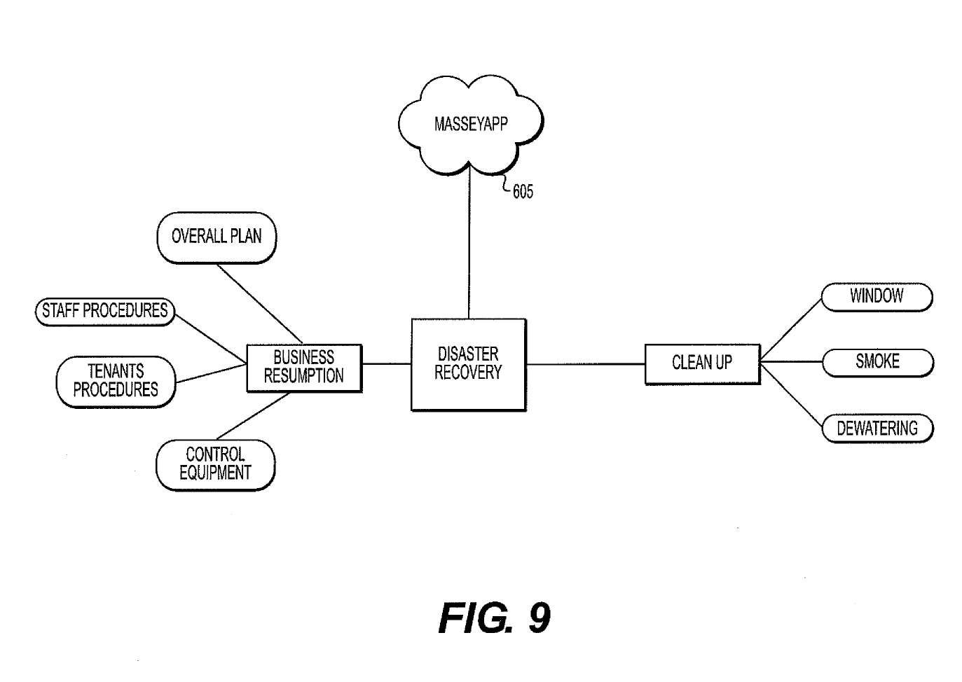

FIG. 8 is a diagram of an embodiment of the present invention showing the organization of day-to-day operation information for building and commercial concerns; FIG. 9 is a diagram of an embodiment of the present invention showing the organization of disaster recovery concerns. FIGS. 8 and 9 provide grouping and sub-grouping in the same manner as shown in FIG. 7, with the information available and the hierarchy and accessibility of the information guided by the particular event or information sought.

FIG. 10 is a diagram of an embodiment of the present invention showing the organization of a public application of the present invention. This embodiment demonstrates access to the same application emergency database 604 as is present in the application regardless of the version, although in this embodiment the database 604 contains information related to individual/personal application rather than professional. In addition, the embodiment shown in FIG. 10 includes a further database of information that is individual-specific; i.e, personal contact information, insurance information, personal medical information, etc.

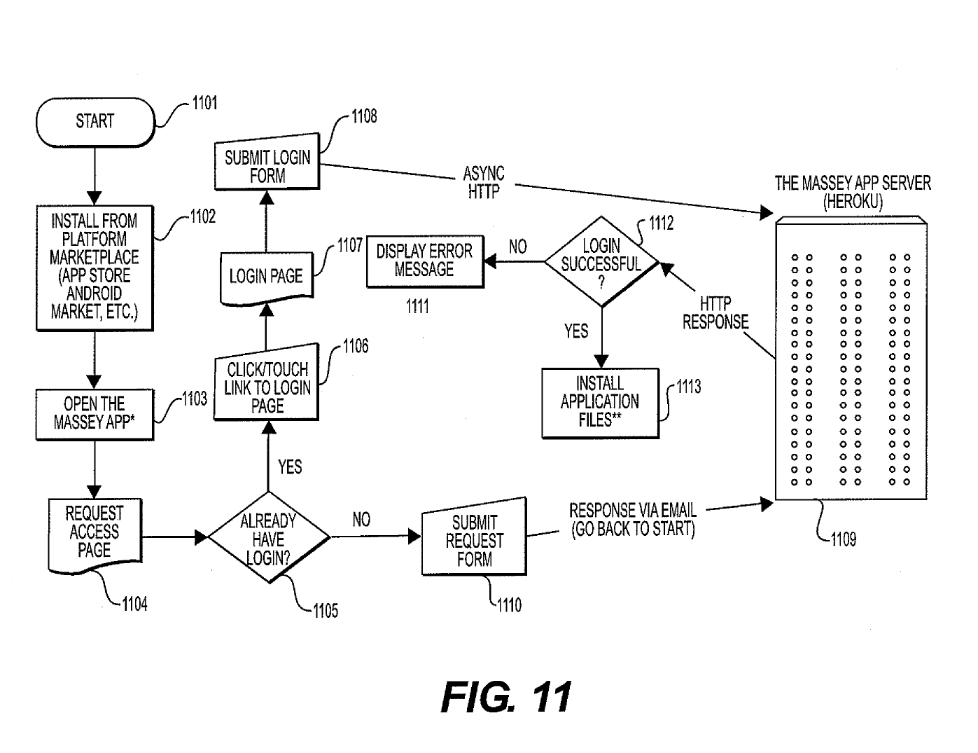

FIG. 11 is a flowchart illustrating an installation process for the present invention. The server 1109 stores the database information. At the start 1101, a user installs 1102 the application from a platform marketplace, and opens 1103 the application. An access page is requested 1104, and the user is queried 1105 to determine if the user already has a login. If not, a request is sent 1110, and the user is provided with an account login via electronic messaging so that the user can then reopen the application (back to 1101-1105). If the user has a login, the user opens 1106 the login link, enters the information in the login page 1106, and submits 1107 the login form. The information is synchronized to the server 1109. The response 1112 is either yes or no; if yes, the server through HTTP response installs 1113 application files for the application. If not, an error message is generated 1111.

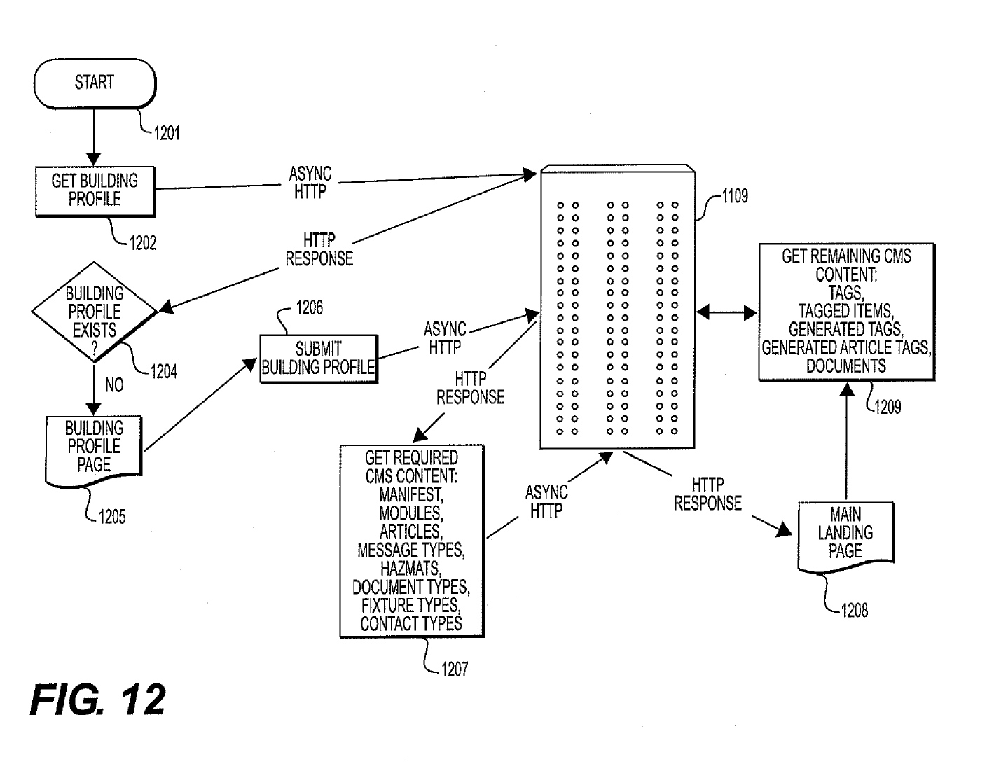

FIG. 12 is a flowchart illustrating the installing of site-specific information for a specific physical location and/or building. From the start 1201, a building profile is requested 1202 from the server 1109 via HTTP link. If the building profile exists, the HTTP response provides building profile information 1207 to the application, and a main landing page 1208 is provided to the user. Remaining content 1209 is then provided to application by the server 1109. If the building profile does not exist 1204, the user is provided with a building profile page 1205, and user-entered data is submitted 1206 to the server 1109. The server stores the information, and provides the HTTP response with the building profile information 1207.

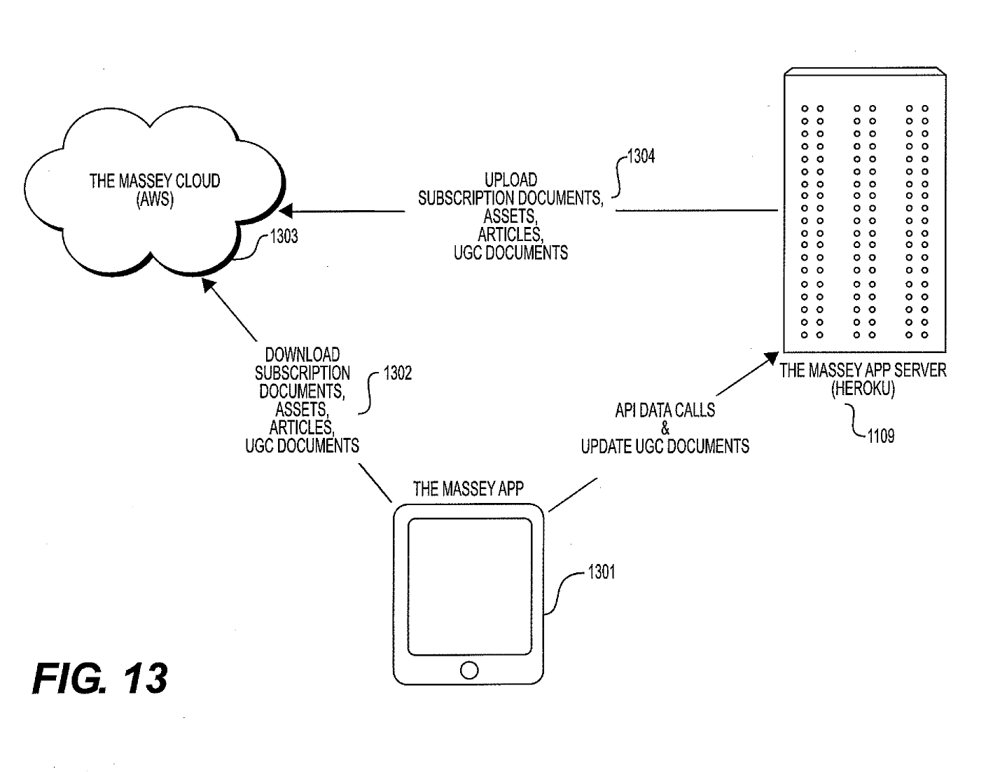

FIG. 13 is a diagram of the interaction of the present invention with a static server and a cloud-based information service. The application is resident on a device 1301 (a tablet device is shown) which synchronizes with the server 1109 via API Data Calls, and allows for UGC documents and other information to be updated. Subscription documents, assets, articles, and UGC documents are downloaded 1302 from the cloud service 1303. The cloud service 1303 uploads the subscription documents, assets, articles, and UGC documents from the server 1109.

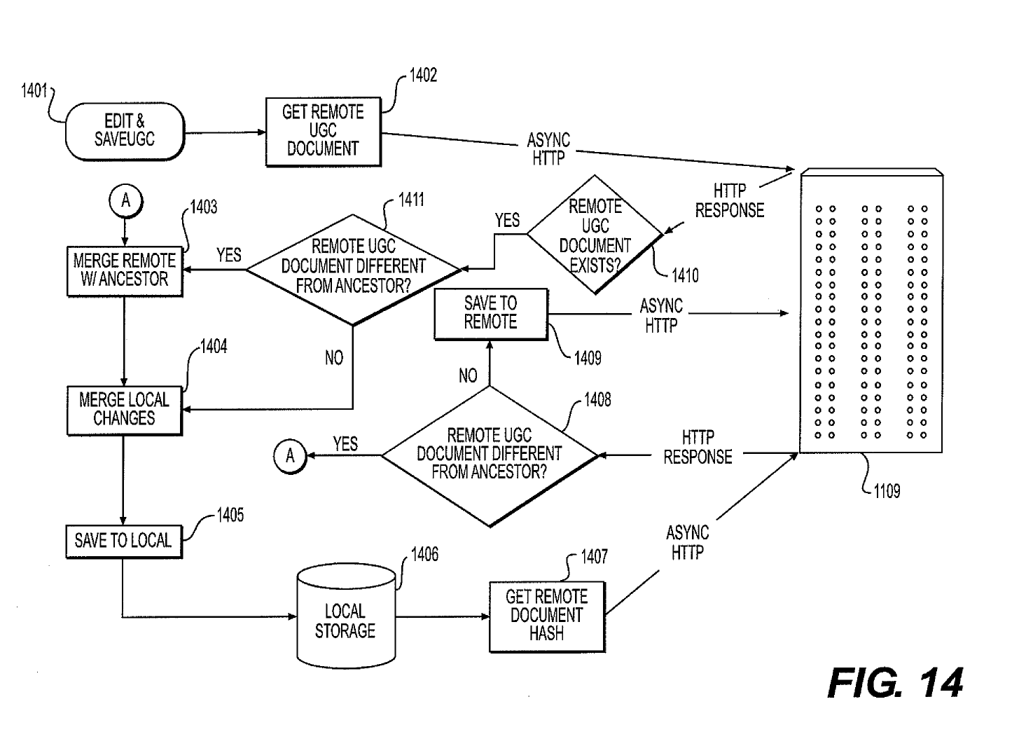

FIG. 14 is a flow chart demonstrating an aspect of the invention where User Generated Content (UGC) is synchronized with a static server and updated in local and static server databases. Where a user has edited and saved a UGC 1401 (the remote document), via HTTP with the server 1109, the remote UGC document is obtained 1402. The query response 1410 in the affirmative then allow's the comparison 1411 to determine if the remote UGC differs from the ancestor document (the server 1109 version of the document), the remote and ancestor documents are merged 1403, local changes are merged 1404, and the merged document is saved 1405 to local storage 1406. Remote document hash (i.e., the digital signature of the document as stored on the server 1109) is obtained 1407, and that information is synchronized with the server 1109 with the merged document. By comparison 1408 it is determined if the documents differ. If the remote UGC document differs from the ancestor then the process reverts to merging 1403 the remote with the ancestor. If not, the document is saved 1409 to the remote.

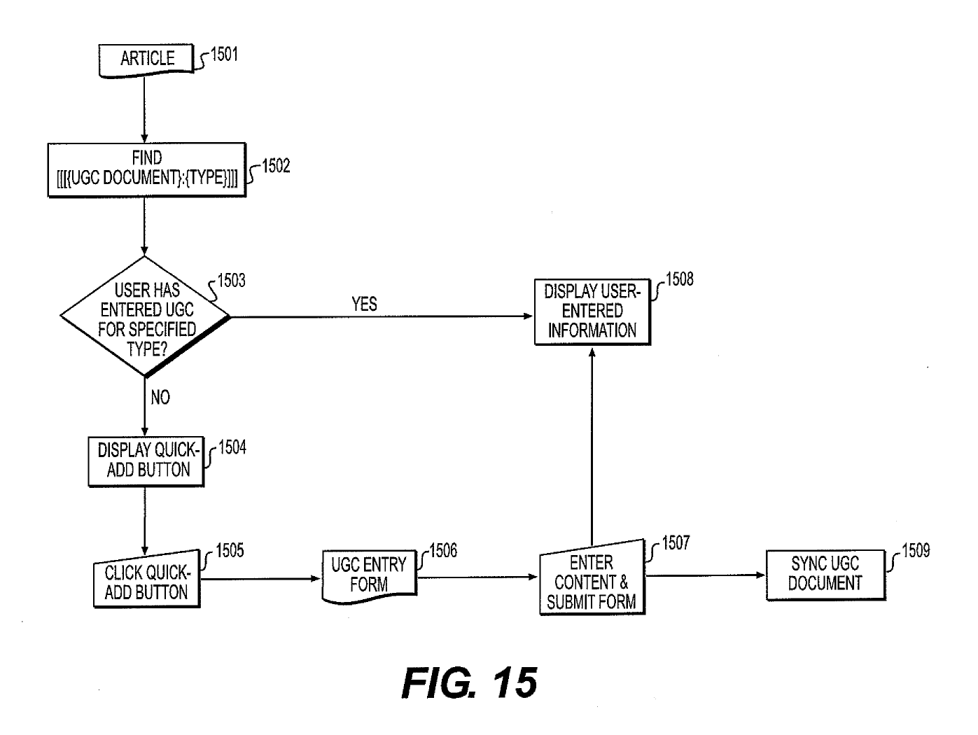

FIG. 15 is a flow chart demonstrating an aspect of the invention where User Generated Content meta- and other data is updated and synchronized between a portable user device database and a static database. A generated article 1501 is compared 1502 to existing document types to determine if the article 1501 is UGC for a specific, preexisting type of UGC. If yes, the user-entered information is displayed 1508, the user enters the content and submits the form 1507 to synchronize 1509 the UGC with the server (not shown in this Figure). If the user has not identified a specific document type, a quick-add button is displayed 1504. The user clicks 1505 the quick-add button, and is redirected to the UGC entry form 1506. The user enters the content and submits the form 1507, which is then synchronized 1509 with the server. Once this process is complete, the UGC is then available for demand or push to end-user devices.

The description above has been provided using specific examples for the purpose of explanation. It will be understood that other modifications and variations are possible without deviating from the scope and spirit of the invention. It will also be understood that the invention disclosed herein is intended to provide a method and means that utilizes well-known devices and inventions for creating, storing, modifying, and communicating information, and that modifications or improvements in the art of mobile devices and information transfer and access do not and should not be understood to negate the inventive nature of the disclosure herein.

What is claimed is:

1. A system for providing disaster and emergency information, the system consisting of a database, the database located on a portable computing device, and a directory allowing an end user to choose one or more multiple items from the directory.

2. The system of claim 1 wherein the said database is updated from a server based outside of the portable computing device.

3. The system of claim 1 wherein the said portable computing device includes communication means.

4. The system of claim 3 wherein the said directory allows an end user to choose items that will utilize the communication means to access information located outside of the portable computing device.

5. The system of claim 3 wherein the database is updated with information from a source outside of the computing device.

6. A method of distributing information to an end user via a server based information distribution service, comprising:
a. For each end user, providing a portable computing device with a database, the database accessible through a directory of items;
b. For each end user, enabling the end user to select multiple items from the directory where one or more the chosen multiple items comprises data contained within the database;
c. For each end user, enabling the end user to select multiple items from the directory where one or more of the chosen multiple items comprises data contained outside of the portable computing device and the said data is distributed over the internet or via telephonic communications to the end user when the end user chooses one or more of the multiple items.

7. A method of distributing information to an end user via a cloud-based information distribution service, comprising:
a. For each end user, providing a portable computing device with a database, the database accessible through a directory of items;
b. For each end user, enabling the end user to select multiple items from the directory where one or more the chosen multiple items comprises data contained within the database;
c. For each end user, enabling the end user to select multiple items from the directory where one or more of the chosen multiple items comprises data contained outside of the portable computing device and the said data is distributed over the internet or via telephonic communications to the end user when the end user chooses one or more of the multiple items.
